(19) United States
(12) Patent Application Publication
(10) Pub. No.: US 2006/0213970 A1
(43) Pub. Date: Sep. 28, 2006

(54) Smart authenticating card

(75) Inventors: Miroslav Trajkovic, Coram, NY (US); Vasanth Philomin, Stolberg (DE); Srinivas Gutta, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.C.

(21) Appl. No.: 10/555,549

(22) PCT Filed: May 5, 2004
(86) PCT No.: PCT/IB04/01392

§ 371 Date: Nov. 4, 2005

Related U.S. Application Data
(60) Provisional application No. 60/469,070, filed on May 8, 2003.

(51) Int. Cl. G06K 5/00; G06Q 40/00

(52) U.S. Cl. 235/380; 235/382; 705/44

(57) ABSTRACT

An authenticating card 10 for use in a transaction includes a memory 15 and a processor 20. Biometric data of an authorized user of the card 10 are stored in the memory 15 when the card is used for the first time. The processor 20 receives acquired biometric information 25 of the user and allows the transaction when there is a match between the acquired biometric information 25 and the stored biometric data. The biometric information 25 of the user desiring to perform the transaction may be acquired by an input device or reader 30, such as a scanner, recorder or a digital tablet. The biometric information 25 and data may be the user's signature, voice print, palm print, finger print, length of finger(s), or eye scan.

The invention relates to memory cards and security methods, and more particularly, to methods and smart authenticating cards that store and compare biometric data.

Many enterprises, such as those dealing with credit cards or any other type of card or device for secure transactions, are introducing so called smart cards which have built in smart chips. The smart cards provide better security for conducting secure transactions. In one conventional secure transaction, biometric data is stored on a smart card. To conduct a transaction, biometric data is obtained from the user, such as signing on a template connected to a server or computer. This acquired signature is compared with a database of signatures of the authorized users stored in the server or computer. The server or computer obtains and compares both the newly acquired signature with the signature stored in the database, and allows the transaction to proceed only when there is a match between the stored and newly acquired signature.

In other secure systems, a card reader is also connected to the server or computer, where the card reader reads both the newly acquired and stored (on the smart card) biometric data. The server, computer or another device such as the card scanner obtains and compares both the biometric data stored on the smart card and the acquired biometric data, and allows the transaction to proceed only when there is a match between the stored and newly acquired biometric data.

Maintaining and accessing a huge database of signatures, as well as performing the verification by some device external to the smart card reduces security and increases cost Accordingly, there is a need for more secure and cost efficient authentication methods and smart cards.

According to one embodiment of the invention, an authenticating card is provided for use in a transaction. The authenticating card includes a memory and a processor. The processor is configured such that biometric data of an authorized user or users of the card are allowed to be stored in the memory when the card is used for the first time by the authorized user or by each authorized user in the case of multiple authorized users. The processor receives acquired biometric information of the user and allows the transaction when there is a match between the acquired biometric information and the stored biometric data. The biometric information of the user desiring to perform the transaction may be acquired by an input device or reader, such as a scanner, recorder, digital tablet or camera.

The biometric information and data may be the user's signature, voice print, palm print, finger print, length of finger(s), or eye scan.

Further features and advantages of the invention will become more readily apparent from a consideration of the following detailed description set forth with reference to the accompanying drawings, which specify and show preferred embodiments of the invention, wherein like elements are designated by identical references throughout the drawings; and in which:

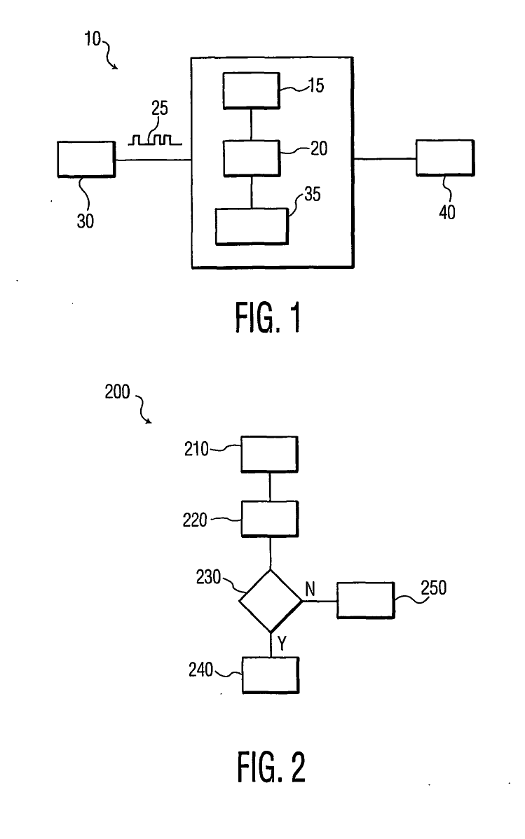

FIG. 1 shows an exemplary authenticating card according to present invention; and

FIG. 2 shows an exemplary method for of verifying authorization of a user of an authenticating card according to present invention.

An authenticating card and method for authenticating transactions are described where authenticating is performed by the authenticating card, using biometric data stored on the authenticating card and acquired biometric information. Thus, there is no longer a need for large databases that store biometric data of authorized card users. Further, authentication is performed by the card itself, thus eliminating the need for external devices to perform the authentication, which increases security and reduces cost.

In the following description, numerous specific details are set forth, such as specific type of authenticating cards, devices connected to the authenticating card, and biometric data. However, it will be obvious to one skilled in the art that the present invention may be practiced without these specific details or with other similar items. In other instances, well known systems have not been set forth in detail in order to not unnecessarily obscure the present invention.

The illustrative embodiments described herein are embodiments of a case where the present invention is applied to performing wide range of secure and private transactions, including accessing secure data, such as personal and/or account information, stored on the authenticating card, a computer, a server and/or a network. The secure transactions include sales or purchase, banking, credit card or other financial transactions, insurance, medical or other secure transactions such as accessing automatic teller machines configured with devices that acquire biometric information 25 as will be described. Thus, the authenticating card may be used for multiple applications for accessing multiple secure data and transactions. Further, the authenticating card may be used by multiple authorized users. The level of security may also be varied, requiring different types and amounts of acquired biometric information. For example, a signature may be enough for low security transactions, while other biometric data may be required for higher security transactions, where the biometrics may be voice print, eye or retinal scan, palm print, finger print, and/or finger length of the authorized user or any other data that identifies the authorized user.

In one embodiment shown in FIG. 1, an authenticating card 10 for use in a transaction comprises a memory structure 15 and a processor 20. Illustratively, the memory structure 15 includes an EPROM portion in which data can only be written and never erased or updated, and an EEPROM portion in which data can be erased and updated. Either or both memory portions may be configured to store biometric data of an authorized user of the authenticating card 10 and other information, such as secure data including personal information and/or account information of the authorized user or users.

Thus, biometric and other secure data of multiple authorized users may be stored in the memory 15, thus providing a versatile authenticating card 10 used for multiple applications by multiple authorized users. The memory 15 also includes instructions and an operating system for the processor 20.

The processor 20 is configured to receive digitized biometric information 25 of the authorized user and to allow continuation of the secure transaction when there is a match between the acquired biometric information 25 and the biometric data stored in the memory 15. Alternatively or in addition, when a comparison between the acquired biometric information 25 and the biometric data stored the memory 15 indicates a match, the processor 20 may be configured to allow access to secure data, such as personal information and/or account information, stored in the memory 15 of the authenticating card 10.

The biometric and other secure data are stored in the memory 15 using various methods. For example, the biometric data is obtained from an input device 30, such as a scanner, template, tablet, recorder, camera or the like, and is stored in the memory 15 only when the authenticating card 10 is used for the first time by each authorized user, where the particular authorized user's biometric data have not yet been stored in the memory 15 of the authenticating card 10. For added security, the biometric and other secure data may be stored in the memory 15 in an encrypted form using well known encryption techniques using random number, public and private keys, hashing functions used to generate biometric keys for well know encryption algorithm, such as DES, triple-DES, and the like, as disclosed in U.S. Patent Application Publication No. US 2002/0,124,176 ('176 Publication), which is incorporated herein by reference in its entirety. For brevity, various details which are not directly related to the present invention, such as different encryption techniques, are not included herein, but are well known in the art such as the system disclosed in the '176 Publication. During subsequent uses, the acquired biometric data 25 from the input device 30 is compared with the biometric data stored in the memory 15 for determination of a match therebetween. A card reader 40 may be coupled to the processor 20 for reading the biometric and/or secure data stored in the memory 15 of the card 10. Alternatively, the card reader 40 may be incorporated into the input device 30.

The biometric data includes a signature, voice print, eye scan, palm print, finger print, and/or finger length of the authorized user or any other data that identifies the authorized user. An appropriate input device 30 is provided for using the authenticating card 10. For example, the input device 30 for a finger print, palm print, and finger length may be a scanner. Other biometrics and associated input devices may be used, such as those disclosed in the '176 Publication, as well as in U.S. Pat. Nos. 6,011,858 and 5,355,411; and U.S. Patent Application Publication No. US 2002/0,196,963, which are incorporated herein by reference in its entirety.

The input device 30 for signature may be a tablet where the user(s) signs where the tablet may either take a graphic image of the signature, or digitizes the signature for comparison by the processor 20 with a counterpart stored in the memory 15. The tablet may be a pressure tablet. Any other instrument for digitizing signatures may be used, such as pen pads, special pens and the like.

In one embodiment, the authenticating card 10 includes a pressure sensitive area or tablet with pressure sensors 35 where the authorized user(s) sign for digitizing and storing the signature(s) in the memory when the authorized user(s) is signing for the first time. As is well known in the art, the pressure sensors 35 include digitizers that capture not only the static signature, but also the writing movement with different pressure levels for storage and later for comparison with acquired signature 25. In this case, the input device 30 used to acquire the signature 25 is also equipped with pressure sensors that also capture parameters, such as writing style and/or the pressure levels of the acquired signature(s) 25. Modules with such pressure sensors are available such as the Sign Smart™ by SOFTRO, as well as other modules with pressure sensors from Fidelica Microsystems, Inc.

In another embodiment, prior to issuing the authorization card 10, the provider thereof requests the biometric data from the authorized user and stores the biometric data in the memory 15. For example, prior to issuing the card, the provider asks the authorized user to sign a document or provide other biometric data. Subsequently upon receipt of the biometric data, the card provider stores the received the biometric data in the memory 15, and then provides the authenticating card 10 to the authorized user. The provider can receive the biometric data by various ways, such as mail, e-mail, facsimile, through the Internet or web site, or through an input device connected to the provider's server or computer.

FIG. 2 shows a flow chart 200 of another embodiment including a method of verifying authorization of a user of the authenticating card 10 to conduct secure, personal or confidential transactions. In block 210, the biometric data of the authorized user is stored in the memory 15 of the authenticating card 10 shown in FIG. 1. As described above, this may be done when the user signs for the first time an authenticating card having pressure sensors 35, provides biometric data to an input device 30 at the point of sale when using the card for the first time where the biometric data is transferred and stored in the memory 15 of authenticating card 10, or the user provides biometric data to the card provider who stores the biometric data in the memory 15 and then provides the authenticating card 10 to the user, for example.

In block 220, when the authenticating card 10 is being used, the user provides the input device 30 with biometric information, which is provided to the processor 20 of the authenticating card 10. In block 230, the processor 20 compares the acquired biometric information received from the input device 30 with the biometric data stored in the memory 15 of the authenticating card 10 retrieved by the card reader 40 or the input device 30, for example. If the acquired biometric information and stored biometric data are equal, then the card the processor 20 allows the transaction to go forward, as indicated in block 240. If there is no match, then the processor 20 stops and prevents continuation of the transaction, as indicated in block 250.

Finally, the above-discussion is intended to be merely illustrative of the present invention and should not be construed as limiting the appended claims to any particular embodiment or group of embodiments. For example, the processor 20 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. An authenticating card for use in a transaction comprising:
a memory which is configured to store biometric data of an authorized user of said authenticating card; and
a processor which is configured to receive biometric information of said authorized user and to allow said transaction when there is a match between said biometric information and said biometric data.

2. The authenticating card of claim 1, wherein said processor is configured to compare said biometric information and said biometric data to determine said match.

3. The authenticating card of claim 1, wherein said transaction includes at least one of a purchase, financial, insurance and medical transaction.

4. The authenticating card of claim 1, wherein said transaction includes access to at least one of said biometric data and secure data stored in said memory.

5. The authenticating card of claim 4, wherein said secure data includes at least one of personal identification numbers and account information of said authorized user.

6. The authenticating card of claim 1, wherein said memory includes at least one additional data of at least one additional authorized user.

7. The authenticating card of claim 1, wherein said biometric data includes a signature of said authorized user, said signature being stored in said memory by reading said signature through pressure sensors of said authenticating card when said authorized user signs for a first time.

8. The authenticating card of claim 1, wherein said biometric data is stored in said memory by at least one of a provider of said authenticating card and reading said biometric information through an input device coupled to said authenticating card when said authorized user uses said authenticating card for a first time.

9. The authenticating card of claim 8, wherein said input device includes at least one of a digital tablet, a scanner, and a camera.

10. The authenticating card of claim 1, wherein said biometric information is provided to said processor by an input device coupled to said authenticating card when said transaction is being performed.

11. The authenticating card of claim 1, wherein said biometric data and said biometric information includes at least one of a signature, voice print, eye scan, palm print, finger print, and finger length of said authorized user.

12. An authenticating card for use in a transaction comprising:
memory means for storing biometric data of an authorized user of said authenticating card; and
processor means for receiving biometric information of said authorized user and allowing said transaction when there is a match between said biometric information and said biometric data.

13. An authenticating system for authenticating an authorized user comprising:
an authenticating card for use in a transaction, said authenticating card having a memory and a processor, said memory being configured to store biometric data of said authorized user of said authenticating card, and said processor being configured to receive biometric information of said authorized user and to allow said transaction when there is a match between said biometric information and said biometric data; and
an input device configured to obtain said biometric information from said authorized user.

14. The authenticating system of claim 13, further comprising a card reader configured to cause said processor to read said biometric data from said memory.

15. The authenticating system of claim 13, wherein said processor is configured to compare said biometric information and said biometric data to determine said match.

16. The authenticating system of claim 13, wherein said transaction includes at least one of a purchase, financial, insurance and medical transaction.

17. The authenticating system of claim 13, wherein said transaction includes access to at least one of said biometric data and secure data stored in said memory.

18. The authenticating system of claim 13, wherein said secure data includes at least one of personal identification numbers and account information of said authorized user.

19. The authenticating system of claim 13, wherein said memory includes at least one additional data of at least one additional authorized user.

20. The authenticating system of claim 13, wherein said biometric data is stored in said memory by at least one of a provider of said authenticating card and reading said biometric information through an input device coupled to said authenticating card when said authorized user uses said authenticating card for a first time.

21. The authenticating system of claim 20, wherein said input device includes at least one of a digital tablet, a scanner, and a card reader.

22. The authenticating system of claim 13, wherein said biometric data includes a signature of said authorized user, said signature being stored in said memory by reading said signature through pressure sensors of said authenticating card when said authorized user signs for a first time.

23. The authenticating system of claim 13, wherein said biometric information is provided to said processor by an input device connected to said authenticating card when said transaction is being performed.

24. A method of verifying authorization of a user of an authenticating card to perform a transaction comprising:
storing biometric data of said authorized user in a memory of said authenticating card;
receiving biometric information of said authorized user by a processor of said authenticating card; and
allowing said transaction when a match between said biometric information and said biometric data is determined by said processor.

25. The method of claim 24, wherein said storing act is performed when said authenticating card is used for a first time.

26. The method of claim 24, further comprising obtaining at least one of said biometric data and said biometric information by at least one of a card reader, a scanner, a digital tablet, and a provider of said authenticating card.
